(19) United States
(12) Patent Application Publication
(10) Pub. No.: US 2021/0286906 A1
(43) Pub. Date: Sep. 16, 2021

(54) MEMORY DEVICE, DATA TRANSFER DEVICE AND METHOD FOR TRANSFERRING DATA

(71) Applicant: Siemens Mobility GmbH, München (DE)

(72) Inventors: Steffen Fries, Baldham (DE); Martin Wimmer, Neubiberg (DE); Rainer Falk, Poing (DE)

(21) Appl. No.: 16/317,847

(22) PCT Filed: Jun. 27, 2017
(86) PCT No.: PCT/EP2017/065750

§ 371 Date: Jan. 15, 2019

(30) Foreign Application Priority Data
Jul. 19, 2016 (DE) 10 2016 213 164.8

(51) Int. Cl. G06F 21/79; G06F 21/85; G06F 21/60

(52) U.S. Cl. CPC G06F 21/79; G06F 21/604; G06F 21/85

(57) ABSTRACT

Provided is a memory device for transmitting data between at least two computer devices, which are assigned to different network zones, which memory device contains at least one memory unit for storing data, at least two interfaces which lead towards the exterior and to which a respective one of the external computer devices can be connected for reading and/or writing data, and at least one control unit which is designed in such a way as to establish access rights to the data of the memory unit as a function of at least two of interfaces which lead towards the exterior. Thus, for example a data transmission can be established exclusively from a first computer device to a second computer device.

### CROSS REFERENCE TO RELATED APPLICATIONS

This application claims priority to PCT Application No. PCT/EP2017/065750, having a filing date of Jun. 27, 2017, based off of German Application No. 10 2016 213 164.8, having a filing date of Jul. 19, 2016, the entire contents both of which are hereby incorporated by reference.

### FIELD OF TECHNOLOGY

The following relates to a memory device, a data transfer device and a method for transferring data between at least two computing devices assigned to different network zones.

### BACKGROUND

In specific areas, such as communication on the part of the authorities, in which stringent security requirements are applicable and which involve a security classification of documents and information, so-called cross-domain solutions are known, which realize an automated and secure exchange of documents and messages, for example emails, between security zones with different degrees of security.

For coupling industrial control networks, such as automation networks, for example, to an office network, the public Internet or other control networks, hitherto use has been made of conventional firewalls that filter the data communication. In this case, the data communication is permitted or blocked depending on the address of the communication partners and the communication protocol used. Moreover, it is customary to route a network connection via an application proxy server that terminates the TCP connection.

In WO 2012/170485, a cross-domain security solution on the basis of a virtualization solution is realized, in the case of which a virtual machine controls an information transfer between two information domains with different levels of security.

EP 2981926 discloses a data-validating dual port memory in which data are read in at a first port and, at a second port of a dual port memory module, the data are visible only whence the data content has been successfully validated.

Furthermore, solid-state drives, so-called SSD disks, are known, having two interfaces. These disks are intended for applications having stringent availability requirements in which two redundant computers access the same disk.

Furthermore, data lock-keepers are known as security gateways for the transfer of data between different classified security zones and the exchange between physically separate networks. This is made possible by the use of a buffer memory, such that two interfaces of the data lock-keeper are only activated alternately. This ensures that a direct connection between the different networks is never set up.

For the data exchange between an office network and a control network, complex solutions with interposed firewalls or virtualization solutions are impracticable if a real-time communication within the control network is not permitted to be delayed by a data transfer. Furthermore, a repercussion-free data transfer must be ensured, that is to say that the data transfer is not permitted to introduce any new or changed data whatsoever into the network from which data are read out.

### SUMMARY

An aspect relates to provide an easily realizable and easily usable solution for repercussion-free data transfer between networks with a varying security requirement or generally between two network zones.

The memory device according to embodiments of the invention for transferring data between at least two computing devices assigned to different network zones comprises at least one memory unit for storing data, at least two externally leading interfaces, to which in each case one of the external computing devices is connectable for reading and/or writing data, and at least one control unit configured in such a way as to establish access rights to the data of the memory unit depending on at least two of the externally leading interfaces.

This makes it possible that each of the at least two external computing devices can write or read or both write and read data to and/or from the memory device. Access rights of each interface to the data of the memory unit are establishable and implementable by means of the control unit. Consequently, by way of example, a data transfer exclusively from a first computing device to a second computing device can be established by the first computing device being connected to a first interface and the second computing device being connected to the second external interface of the memory device and only writing access to the data of the memory unit being established as access right for the first external interface and exclusively reading access to said data being established for the second external interface in the control unit. A repercussion-free transfer is thus ensured. The access rights are moreover structured in a simple manner and simple to establish.

The computing devices are, in particular, autonomous devices separate from the memory device. In this case, interface-dependent access rights are, for example, an authorization for read access or write access or read and write access by the computing device to data of the memory device via the externally leading interface under consideration. In this case, the computing device is connected to the memory device via one of the externally leading interfaces. In this case, only reading access, only writing access, or read and write access via the interface under consideration to the memory unit can be enabled. Different write-read authorizations can be present at the at least two interfaces of the memory device. The term “external interface” is used synonymously with “an externally leading interface”. Likewise, the term “port” is used synonymously with “interface”.

In one advantageous embodiment, the memory unit is configured in such a way as to store data in different data structures, and the control unit is configured in such a way as to establish access rights for such a data structure in an interface-dependent manner.

In this case, data structures are for example a partition, a directory or a file. By way of example, a different volume of data is storable in each of these data structures. The access to data via the respective interface can thus be established granularly to the corresponding data structure. Consequently, different access rights can also be established for different data structures. In this regard, by way of example, data of a specific partition can be transferred exclusively from a first external interface to the second external interface, whereas data are exclusively written to a second partition from the second interface and read out via the first interface and a data transfer in the opposite direction is thus possible. It is likewise possible to establish a reading and a writing access to one of the data structures only from a first interface and to permit no access to this data structure via the second interface, such that the memory device can also be used for “stockpiling” data.

In one advantageous embodiment, the access rights are implemented by means of interface-dependent authorization information in a file system of the memory device.

This has the advantage that access rights are changeable more easily and more rapidly by comparison with a direct implementation of the access rights on the interfaces.

In one advantageous embodiment, the access rights are implemented by means of a configuration of the external interfaces themselves.

In the case of a configuration of the external interfaces of the memory device, by way of example, an interface is configured as a read-only interface. Consequently, a different type of transfer can be excluded with very high probability. A control of the access rights by means of additional interrogations in the control unit, for example, is no longer necessary according to such a configuration. Consequently, access rights implemented in this way are very reliable vis-à-vis freedom from repercussions and transfer security, and also very fast with regard to transfer security.

In one advantageous embodiment, the access rights are formed by means of short-circuiting jumpers or DIP switches.

As a result, it is possible to realize a one-way communication with high reliability.

For an implementation of the access rights by means of a combination of configurations of the interfaces and authorization information in a file system, attributes concerning a file structure which are stored on a file system are checked during an access to the file structure. In this regard, a specific file structure can be assigned authorization information such as read-only or write-only or read-and-write authorizations by the first port and write-only or read-only or read-and-write authorizations by the second external port. Authorization information can also be extended by further attributes tied to the different read and/or write authorizations.

In one advantageous embodiment, separate data structures are configured for different access rights or different access rights can be configured for a single data structure.

Separate data structures for different access rights have the advantage, for example, that an erroneous access to data is minimized. A data structure which is only read-authorized for example for a first interface or a data structure which is only write-authorized with regard to the second interface contains no data written from the first interface. Different access rights for a single data structure have the advantage that when a large volume of data is transferred, the available memory space can be utilized in an optimized manner since a separate data structure is not reserved and thus for example a fixed data capacity is reserved for a different communication direction, for example.

In one advantageous embodiment, separate data structures are configured for different access rights or different access rights are configured for a single data structure.

Management data here are for example information as to when a file was written to a data structure or the information that the file is ready to be fetched. Further management data are for example information that a file that was ready was read and can therefore be erased again for example by the setting-up entity. Information concerning errors that have occurred, for example when reading the data, can furthermore be stored as management data. If these management data are stored in a dedicated data structure, then an inadvertent transfer of such management data instead of payload data is minimized.

In one advantageous embodiment, the control unit checks data vis-à-vis a checking specification before forwarding to an external interface.

In particular checking the data by means of checksums for correct transfer or for checking integrity can be carried out in the control unit. This is expedient in particular if one of the external interfaces is connected to a zone in which malware can potentially occur. In this case, the control unit can be used to check the data in the respective data structures before the access is enabled by the respective other interface.

In one advantageous embodiment, a first control unit checks the data arriving at an interface vis-à-vis input rules and a second control unit checks the data emerging at an interface vis-à-vis output rules.

The input or output rules mentioned are often also referred to as an access policy for the first or respectively second external interface.

In one advantageous embodiment, in the control unit in addition to a read and/or write authorization an access right is establishable depending on a role of the reading and/or writing external computing device.

This has the advantage that the access right of a computing device that is connected to a first externally leading port can be configured differently depending on the role of the computing device.

In one advantageous embodiment, in the control unit an access right is establishable and/or checkable depending on an information path of the data written to the memory unit and/or data read from the memory unit.

In this case, an information path is defined as a number of items of information which give indications about, for example, components of the computing device which the data have passed through before being written to the memory device. These are for example items of information about the user of the data. In this regard, by way of example, data used for booting hardware can be identified as such. Correspondingly, data concerning the operating system of a computing device, for example, can be identified as such or data for an application can be identified as such and can be contained as an indication in the information path. The information path furthermore contains an identifier of the computing device or for example an identifier of the external interface via which the data are read into the memory device. In the control unit, an access right to an external interface is established depending on the indications mentioned. In the case of an access by a computing device via an external interface of the memory device, an information path, that is to say the indications mentioned, is read into the memory device and checked by the control unit vis-à-vis the access rights and resulting rights are allocated. This allows access rights to be controlled very flexibly and depending on different properties or boundary conditions.

In one advantageous embodiment, the memory device is configured as a mass storage device, in particular as a solid-state drive SSD, as a hard disk drive HDD, as a redundant array of independent disks RAID or as a direct access storage device DAS.

As a result of the use of commercially available dual-port SSD drives, for example, a memory device according to embodiments of the invention can be provided cost-effectively and with only little modification outlay.

Furthermore, the use of a memory device having the properties described as a data transfer device, often referred to as a data gateway, for transferring data between different zones of a network is claimed. The data transfer device according to embodiments of the invention for transferring data between different network zones comprises
at least two computing devices assigned in each case to different network zones and
a memory device comprising at least two externally leading interfaces,
   wherein the at least two computing devices are connected to different externally leading interfaces of the memory device, and
   the memory device is configured in such a way as to establish access rights to data of the memory device depending on the accessing interface.

The method according to embodiments of the invention for transferring data between at least two computing devices assigned to different network zones, wherein a first computing device is connected to a first externally leading interface of a memory device and a second computing device is connected to a second externally leading interface of the memory device, which is different than the first externally leading interface, comprises the following method steps:
establishing interface-dependent access rights to the data of the memory device depending on the at least two of the externally leading interfaces of the memory device,
writing data from an external computing device via a first externally leading interface of the memory device depending on the established access rights for the first externally leading interface,
reading data out by means of a second computing device via a second externally leading interface depending on the established access rights for the second externally leading interface.

The method makes it possible to establish interface-dependent access rights at a memory device having at least two external interfaces and to apply them to data subsequently read in or out. As a result, such a memory device becomes usable for transferring data between zones of varying security relevance in a network.

In one advantageous embodiment, the access rights are additionally established depending on an information path, and the information path is provided via the externally leading interface. In particular, the information path additionally has at least one of the following indications: an indication concerning the role of the computing devices, an indication concerning the type of data source or respectively data sink of the computing device and an identifier of the data sink or respectively data source.

By means of these additional indications in the information path, access rights can be fashioned and established very flexibly. This is not an exhaustive list of indications which an information path can contain. Further obvious indications concerning the data source and/or data sink and/or the path traversed by the data are included in the scope of protection. One indication concerning the role of the data source is for example the use of the computing device as a service terminal. Indications concerning the type of data source are for example indications as to whether hardware, software or application-related data is/are involved. This can also be indicated in the form of an attestation by a trustworthy module (Trusted Platform Module, TPM). An identifier of the data sink or respectively data source can be for example a processor identifier or an EPID (Enhanced Privacy Identity) authentication or an interface identifier of a memory device in the computing device.

Furthermore, a computer program product (non-transitory computer readable storage medium having instructions, which when executed by a processor, perform actions) is claimed which is directly loadable into a memory of a programmable memory module, comprising computer code parts suitable for carrying out the steps of the method as described. Furthermore, a data carrier which stores the computer program product is claimed.

### BRIEF DESCRIPTION

Some of the embodiments will be described in detail, with reference to the following figures, wherein like designations denote like members, wherein:

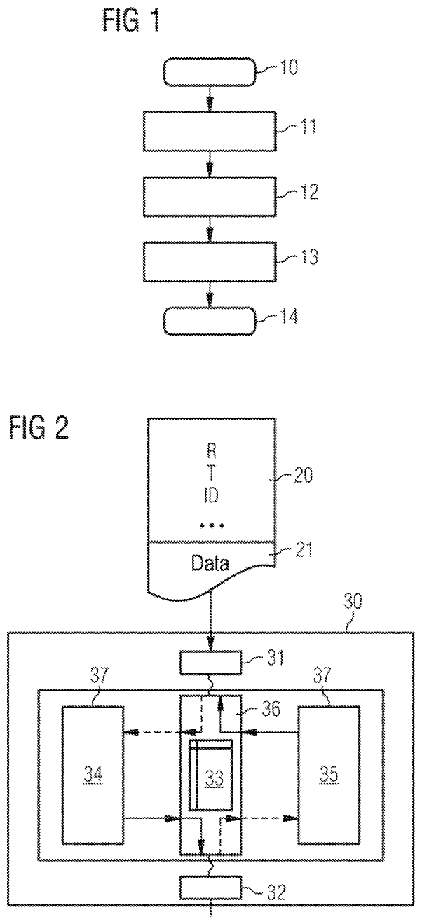

FIG. 1 shows one exemplary embodiment of the method according to the invention as a flow diagram;

FIG. 2 shows one exemplary embodiment of the method according to the invention with a transfer of path information to a first exemplary embodiment of a memory device according to the invention in a schematic illustration;

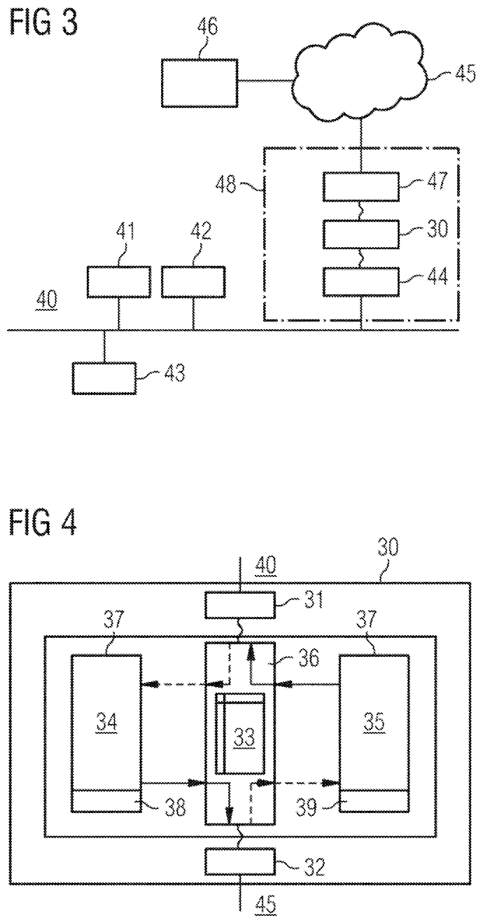

FIG. 3 shows one exemplary embodiment of a data transfer device according to the invention in one exemplary application scenario in a schematic illustration;

FIG. 4 shows a first exemplary embodiment of a memory device according to the invention in a block illustration;

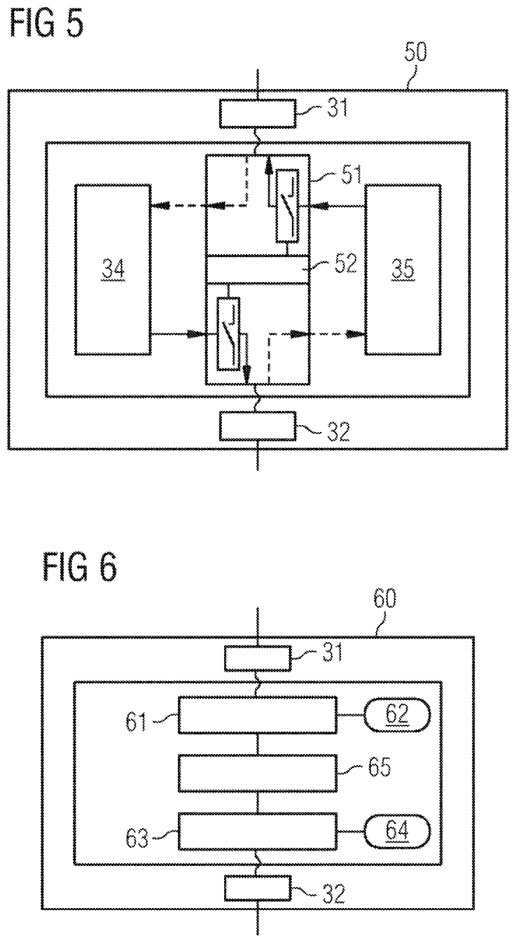

FIG. 5 shows a second exemplary embodiment of a memory device according to the invention with a checking specification in a block illustration; and

FIG. 6 shows a third exemplary embodiment of a memory device according to the invention with the checking of data vis-à-vis input and output rules, respectively.

Mutually corresponding parts are provided with the same reference signs in all the figures and have the same configuration, unless described otherwise.

### DETAILED DESCRIPTION

FIG. 1 shows the method according to embodiments of the invention in a schematic illustration. In the initial state 10, a memory device having at least two external interfaces for reading and/or writing data is present. Each of the interfaces is connected to a directly connectable external computing device functioning as data sink and as data source, respectively. The two computing devices can function as lock-keeper computers. The first computing device is connected for example to a security-critical zone of a network. The second computing device or the second lock-keeper computer is connected to a second zone of the network, said second zone having for example less stringent security requirements. In the method described, the memory device performs the function of a data lock-keeper.

For this purpose, method step 11 involves establishing interface-dependent access rights to the data of the memory device on the basis of at least one information path. In this case, the information path contains at least one indication concerning the external interface of the memory device that is used. In the simplest case, by way of example, only a write access to the data of the memory device can be established for the first interface, and only a read access to the data of the memory device can be established for the second external interface. A data transfer can thus take place from the first interface to the second interface or from the first computing device directly connected to the first interface to the second computing device connected to the second external interface of the memory device. However, it is also possible for both a reading and a writing access right to be established for each external interface. In particular, the memory device can contain a plurality of different data structures and access rights can be established for each of these data structures in an interface-dependent manner.

By way of example, separate data structures can be configured for different access rights. By way of example, one data structure can be established only for a data transfer in one direction, and a further data structure for data transfer in the opposite direction. An asynchronous handling of the transmission direction of the memory device is achieved as a result. A data structure can be a partition, a directory or a file. Depending on the configuration of the port-specific access rights, a one-way communication or a network separation can be realized with the memory device. Just a network separation by itself can prevent network-based attacks from spreading.

However, a data structure can also be configured for different access rights, such that a data structure can be used for a data exchange in both directions. Alternatively, a data structure can only have access rights for one transfer direction.

It is also possible to configure data structures which store only management data or only payload data. Furthermore, checking specifications can be checked by a control unit of the memory device. It is only in the event of a positive checking result that the data transfer is performed in accordance with the access rights. In particular, the interface-dependent access rights can be established depending on further indications of, in particular, an information path. Such indications of an information path are the role of the data source or respectively of the data sink, indications concerning the type of data source, the type of transferred data themselves and an identifier of the data sink or respectively data source. Establishing the access rights can be carried out when a memory device is started up. Access rights can be changed or erased and new access rights can be added. This can be restricted to specific operating modes of the memory device or can be possible during ongoing operation.

When reading in data, see method step 12, from an external computing device via an external interface, the established access rights for this interface are checked. Besides the interface that provides the data, the data themselves and the information path of the memory device can be provided. The access rights for the assigned data are selected on the basis of these indications. The data are then written to the memory device in accordance with the access rights determined. In method step 13, before data are read out via a second external interface to a second external computing device, the access rights of the second interface to the memory device are checked. Here, too, path information concerning the reading-out data sink can be checked. The data sink here is the second computing device or an application established in the second computing device. In the event of a positive checking result, the second computing device reads out the data. Consequently, via the memory device, data can be forwarded between two network zones in a controlled manner. The path-based data transfer by means of the memory device thus ends, see state 14.

FIG. 2 shows method step 12, that is to say the step of reading in data into a memory device 30 using path information 20. The memory device 30 comprises a first external interface 31 and a second external interface 32. The memory device 30 comprises a memory unit 37 composed of two logical data structures 34 and 35. In this case, the access rights 33 in a control unit 36 are established in such a way that a write access to the data structure 34 is allowed by the first interface 31. On the other hand, only reading access to the data structure 35 can be effected via the first external interface 31. In the example illustrated, the access rights for the second interface 32 are established in such a way that only a reading access to the data structure 34 is allowed and a writing access to the data structure 35 is possible.

Together with the data 21 to be transferred, an information path 20 is provided to the first external interface 31. The control unit 36 then checks the indications in the information path 20 on the basis of the access rights 33 and stores the provided data in accordance with the access rights determined. If a read access via a second external interface 32 is requested, then the access rights of the second external interface 32 to the data are checked on the basis of the established access rights. Here, too, path information can be provided by the second computing device and taken into account during the checking of the access rights. If the read access is allowed, the data are output via the second interface 32. The data are thus forwarded from a first computing device to a second computing device.

Besides the information about the external interface via which the data are read in, the information path 20 comprises for example indications concerning the role R, the type T or an identifier ID of the data source.

FIG. 3 illustrates one application scenario for the described memory device 30 and a data transfer device 48. A first zone 40 of a data network is an automation network, for example. Components 41, 42, 43, for example field devices, are connected therein. Such a first network zone 40 usually has particularly stringent requirements with regard to data security, particularly if these are used as a safeguard system for example for train control or train signal control or else in energy installations. Such a first network zone 40 is usually configured as a closed network and a data transfer from a less secure second network zone 45 into the first network zone 40 or else the transfer of data from the first network zone into the second network zone 45 is possible only under strict conditions. To that end, particularly in the case of a data transfer from the first zone 40 into the second zone 45, it must be ensured that no data from the second zone 45 are introduced into the first zone or data from the first zone 40 are altered and transferred back into the first zone 40. A simple possibility for channeling data into a second network zone 45 is of interest in particular for the evaluation of diagnosis data of the components of the first network zone 40.

The memory device 30 in this case serves as a data lock-keeper and, together with two computing devices 44, 47 as lock-keeper computers, forms a data transfer device 48, also referred to as a data gateway.

The memory device 30 according to embodiments of the invention is illustrated in a simplified manner here and corresponds to the memory device 30 illustrated in a detailed manner in FIG. 4. It comprises a first external interface 31, to which a first computing device 44 of the first network zone is connected. In this case, external interface denotes an interface via which data from outside the data lock-keeper can be read into the data lock-keeper or data from the data lock-keeper can be read out toward the outside into a connected computing device. A second external interface 32 of the memory device 30 is then connected to the second network zone 45, for example a computing device 47. Data stored on a memory unit 37 can in each case be accessed via the first or respectively second interface 31, 32. By means of the access rights for the first or respectively second interface that are configured in the memory device 30, not only a network separation but also a controlled data exchange between the first zone 40 and the second zone 45 is possible. By way of example, if only a writing access to the memory unit 37 is established for the first interface 31, then data can be written from the first network zone 40 to the memory unit 37. If only a reading access to the memory unit 37 is granted for the second interface 32, for example a diagnosis computer 46 connected to the second interface 32 via an office network can read out diagnosis data into the second zone 45.

Consequently, an open data channel is not used for data exchange, rather the data transfer is made possible by a buffer-storage of the data in the memory device and the interface-dependent access rights to the memory unit.

The memory device 30 is operated with a respective lock-keeper computer connected to a respective one of the external interfaces 31, 32 of the memory device. Both lock-keeper computers 44, 47 have access to a shared file system that is physically mapped in the memory unit 37 of the memory device. A lock-keeper computer 44 connected to the interface 31 can for example interrogate diagnosis data from the field devices 41, 42, 43 and store the result as a file on the memory unit 37 of the memory device. There the file can be read out by a lock-keeper computer 47 connected to the second interface 32 and be transferred for example via the Internet 45 to a cloud service 46 for evaluation. Likewise, in the opposite direction, for example, a firmware update can be transferred from the second zone 45 into the automation network 40 in a controlled manner. Within the memory device 30, by means of a control unit 36 it can then be ensured that the memory units or data structures 34, 35 established on the memory unit are readable or writeable only from one direction in each case.

FIG. 4 illustrates the memory device 30 in an enlarged manner. A control unit 36 controls the access rights of the first and second interfaces 31, 32, respectively, to the data or the data structures 34, 35. In this case, the control unit 36 monitors the access rights defined for the interfaces 31 and 32, respectively, said access rights being illustrated here schematically as a unit 33. However, the access rights can also be configured by way of short-circuiting jumpers, also referred to as jumpers, or as DIP switches. The access right is thus implemented physically. However, the access rights can also be predefined by a file system set up in a complex control unit of the memory device or in the connected computing devices 44, 47. In this case, in the file system, read and/or write rights for an output to the interface of the memory device 30 are predefined, monitored and thus implemented for data structures such as, for example, a partition or a directory or a file. In addition, areas for management data 38, 39 can be configured in the memory unit 37.

The memory device 50 in FIG. 5 shows a further embodiment comprising two interfaces 31, 32, two data structures 34, 35 and a control unit 51. The control unit 51 additionally comprises a checking function 52, which, in each case regarding data before being read in or out by a computing device connected to the interface 31 or 32, respectively, checks the data vis-à-vis a checking specification. This is expedient in particular if one of the interfaces is connected to a network zone in which harmful code or a manipulation can potentially occur. In this case, the control unit 51 can be used to check the data in the respective data structures before the access is enabled by the respective other side. As a checking specification, it is possible for example to evaluate a checksum of the data or to compare it with the current checksum formed by way of the data.

A computing device connected to the interface 31, 32 can validate a file after reading, for example can carry out a format check, before the computing device accepts the file. Via a network interface, data can be loaded from or to the computing device in the respective network zone.

FIG. 6 shows a memory device 60 in which, as an alternative realization variant, two control units 61, 63 are embodied, which respectively implement an input and output rule 62, 64, also called access policy. An access to the memory unit or the data structures is only possible via the control unit provided that the access is permitted in accordance with the respective input and/or output rules. In this case, a control unit is divided into two separate entities as an input control unit 63 and an output control unit 61, which in each case check data written to the memory unit 65 vis-à-vis input rules 64. The output control unit 61 checks the data read out vis-à-vis output rules 62 before said data are output via the interface 31 to a linked computing device.

Consequently, a reliable lock-keeper solution or a data gateway is realizable in a cost-effective manner. The network connectivity between a first and second network zone is interrupted in this case. By way of a corresponding configuration, that is to say by way of the access rights, the read and write rights can be correspondingly restricted depending on the interface. An asynchronous handling for each transmission direction can thus be achieved. Furthermore, data can be temporarily buffered and checked or validated according to various criteria. As a result of defining interface-dependent authorizations to substructures of the memory unit, that is to say as a result of establishing partitions, directories or files, and access rights directed thereto, data streams can be flexibly separated and forwarded or else only stored according to various rules. As a result of including indications taking account of the processing path or path of origin of the data read in or written, the transfer of different types of data can be taken into account very flexibly.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A memory device for transferring data between at least two computing devices assigned to different network zones, comprising:
at least one memory unit for storing data,
at least two externally leading interfaces, to which in each case one of the computing devices is connectable for reading and/or writing data, and
at least one control unit configured in such a way as to establish access rights to the data of the memory unit depending on at least two of the externally leading interfaces.

2. The memory device as claimed in claim 1, wherein the memory unit is configured in such a way as to store data in different data structures, and the control unit is configured in such a way as to establish access rights for each data structure in an interface-dependent manner.

3. The memory device as claimed in claim 1, wherein the access rights are implemented by interface-dependent authorization information in a file system of the memory device.

4. The memory device as claimed in claim 1, wherein the access rights are implemented by a configuration of the external interfaces to the memory unit themselves.

5. The memory device as claimed in claim 4, wherein the access rights are formed by short-circuiting jumpers or DIP switches.

6. The memory device as claimed in claim 2, wherein separate data structures are configured for different access rights and/or different access rights are configured for a single data structure.

7. The memory device as claimed in claim 2, wherein separate data structures are configured for management data and payload data.

8. The memory device as claimed in claim 1, wherein the control unit checks data vis-à-vis a checking specification before forwarding to an external interface.

9. The memory device as claimed in claim 1, wherein a first control unit checks the data arriving at the first external interface vis-à-vis input rules and a second control unit checks the data emerging at the second external interface vis-à-vis output rule.

10. The memory device as claimed in claim 1, wherein in the control unit in addition to a read and/or write authorization an access right is establishable depending on a role of the reading and/or writing external computing device.

11. The memory device as claimed in claim 1, wherein in the control unit an access right is establishable and/or checkable depending on an information path of the data written to the memory unit and/or data read from the memory unit.

12. The memory device as claimed in claim 1, wherein the memory device configured as a mass storage device, including a solid-state drive, a hard disk drive, a redundant array of independent disks or a direct access storage device.

13. A data transfer device for transferring data between different network zones, comprising
at least two computing devices assigned in each case to different network and
a memory device comprising at least two externally leading interfaces,
wherein the at least two computing devices are connected to different externally leading interfaces of the memory device, and
the memory device is configured in such a way as to establish access rights to data of the memory device depending on the accessing interface.

14. A method for transferring data between at least two computing devices assigned to different network zones, wherein a first computing device is connected to a first externally leading interface of a memory device and a second computing device is connected to a second externally leading interface of the memory device, which is different than the first externally leading interface, comprising the following method steps:
establishing interface-dependent access rights to the data of the memory device depending on the at least two of the externally leading interfaces of the memory device,
writing data from an external computing device via a first externally leading interface the memory device depending on the established access rights for the first externally leading interface,
reading data out by a second computing device via a second externally leading interface depending on the established access rights for the second externally leading interface.

15. The method as claimed in claim 14, wherein access rights are additionally established depending on an information path, and the information path is provided via the externally leading interface.

16. The method as claimed in claim 15, wherein the information path has at least one of the following indications:
an indication concerning the role of the computing device, an indication concerning the type of data source or respectively data sink of the computing device and an identifier of the data sink or respectively data source.

17. A computer program product, comprising a computer readable hardware storage device having computer readable program code stored therein, said program code executable by a processor computer system implement a method, which is directly loadable into a memory of a programmable memory module, comprising program code parts suitable for carrying out the steps of the method as claimed in claim 14.

18. A data carrier which stores the computer program product as claimed in claim 17.
